(19) United States
(12) Patent Application Publication
(10) Pub. No.: US 2025/0337525 A1
(43) Pub. Date: Oct. 30, 2025

(54) ESTIMATING DEVICE

(71) Applicant: TOYOTA JIDOSHA KABUSHIKI KAISHA, Toyota-shi (JP)

(72) Inventor: Kyosuke Togashi, Toyota-shi (JP)

(73) Assignee: TOYOTA JIDOSHA KABUSHIKI KAISHA, Toyota-shi (JP)

(21) Appl. No.: 19/033,717

(22) Filed: Jan. 22, 2025

(30) Foreign Application Priority Data
Apr. 25, 2024 (JP) 2024-071520

(51) Int. Cl. H04L 1/00

(52) U.S. Cl. CPC H04L 1/0061

(57) ABSTRACT

The estimating device estimates a failure mode of a communication line in a communication system including a plurality of communication devices in which communication based on a CAN protocol is performed via a communication line. The estimating device includes a storage device and an execution device. The storage device stores relation information including error information including a plurality of types of detection item DE related to a communication protocol error, and a failure mode associated with each detection item DE. The processor is configured to acquire a DE of detection items related to a communication protocol error. The execution device estimates that the failure has occurred in the failure mode associated with the acquired detection item DE.

### CROSS-REFERENCE TO RELATED APPLICATION

This application claims priority to Japanese Patent Application No. 2024-071520 filed on Apr. 25, 2024, incorporated herein by reference in its entirety.

### BACKGROUND

### 1. Technical Field

The present disclosure relates to an estimating device.

### 2. Description of Related Art

Japanese Unexamined Patent Application Publication No. 2021-034914 (JP 2021-034914 A) describes a detection device for detecting a communication state of a communication line in a communication system. In the communication system, a plurality of the communication devices perform controller area network (CAN) protocol based communication via the communication line. The detection device acquires voltage of the communication line by bringing an electrode close to the communication line. The detection device detects the communication state of the communication line based on the voltage that is acquired.

### SUMMARY

Now, the detection device may, at times, estimate a type of a failure of the communication line based on the communication state of the communication line. However, with a detection device such as that described in JP 2021-034914 A, for example, when acquiring time-series data of the voltage of the communication line over a certain period of time, there is concern that analysis of failure by the detection device will become complicated, due to the amount of data to be acquired becoming excessively great.

In order to solve the above problems, the present disclosure provides an estimating device that estimates a failure mode of a communication line in a communication system that includes a plurality of communication devices in which communication based on a controller area network protocol is performed via the communication line, the estimating device including
a storage unit, and an execution unit, in which
the storage unit stores relation information that includes error information including a plurality of types of detection items related to communication protocol errors, and the failure mode associated with each of the detection items, and
the execution unit executes acquiring, from the communication device, the detection item that is detected by the communication device, and estimating that a failure is occurring in the failure mode associated with the detection item that is acquired.

According to the above configuration, the execution unit acquires, from the communication device, multiple types of detection items related to the communication protocol error that is detected by the communication device. The execution unit then estimates that the failure has occurred in the failure mode associated with the detection item that is acquired. Accordingly, the estimating device does not have to perform analysis, based on the voltage of the communication line, regarding the detection item related to the communication protocol error that has been detected by the communication device based on the voltage of the communication line. Thus, the estimating device can realize estimation of the failure mode without performing excessively complicated processing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a communication system and an estimating device;

FIG. 2 is a schematic diagram showing relation information;

FIG. 3 is a flow chart illustrating a process for generating relation information; and

FIG. 4 is a flowchart illustrating a series of processes including estimation of a failure mode.

### DETAILED DESCRIPTION OF EMBODIMENTS

Hereinafter, an embodiment of an estimating device for estimating a failure mode of a communication line in a communication system will be described with reference to the drawings.

### Outline of the Communication System

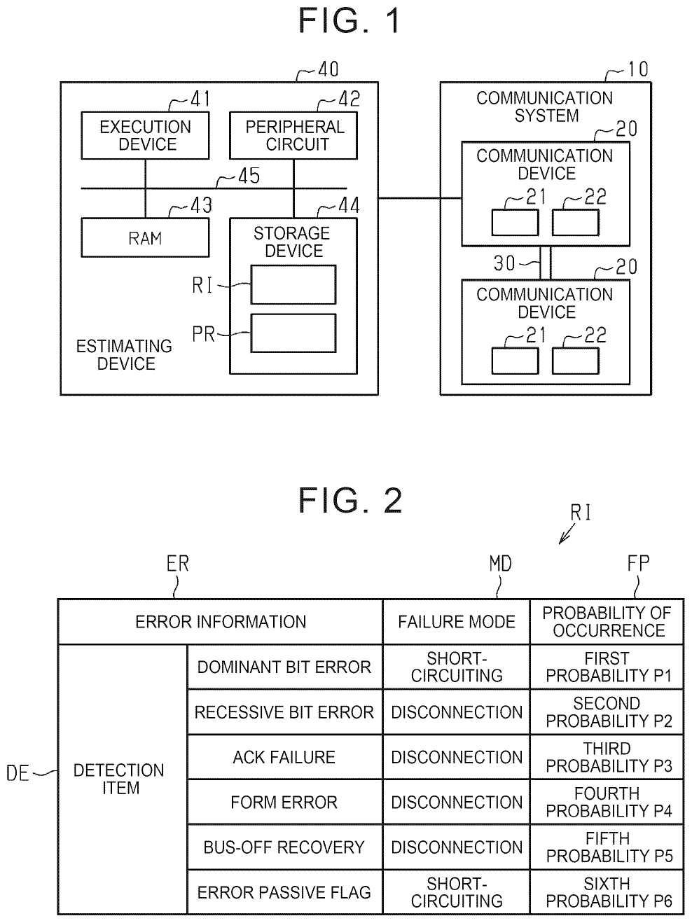

As shown in FIG. 1, first, the communication system 10 will be described. The communication system 10 is mounted on a vehicle. The communication system 10 includes a plurality of communication devices 20 and a communication line 30. The plurality of communication devices 20 are connected by a communication line 30. The communication device 20 performs CAN (Controller Area Network) protocol-based communication via the communication line 30. The plurality of communication devices 20 are, for example, an electronic control unit that controls the engine of the vehicle and an electronic control unit that controls the brake of the vehicle.

The communication line 30 has two signal lines. The difference between the voltages of the two signal lines is a digital signal composed of “0” and “1” in the communication based on CAN protocol. A digital signal of “0” is dominant, and a digital signal of “1” is recessive. The dominant state is a state in which there is a potential difference, and the recessive state is a state in which there is no potential difference. The dominant signal is a dominant level signal, and the recessive signal is a recessive level signal. That is, the communication device 20 generates a digital signal by controlling the difference in voltages between the two signal lines in the communication line 30.

The communication device 20 uses the digital signal to transmit a data frame having a frame structure that is a predetermined form to another communication device 20 via the communication line 30. The frame construction of the data frame includes an SOF, ID, RTR, control field, data field, CRC field, ACK field, and EOF. SOF is an abbreviation for Start of Frame. RTR is an abbreviation for Remote Transmission Request. CRC is an abbreviation for Cyclic Redundancy check. ACK is an abbreviation for Acknowledgement. EOF is an abbreviation for End of Frame. CRC fields include CRC sequencing and CRC delimiters. ACK fields include ACK slots and ACK delimiters. Details of the structure are not described since they are well known.

The communication device 20 includes an execution unit 21 and a storage unit 22. The execution unit 21 transmits the data frame using the digital signal. The execution unit 21 detects a communication protocol error by monitoring the transmitted data frame. The execution unit 21 detects a communication protocol error by monitoring a received data frame. The communication protocol error is detected based on the digital signal, that is, the voltage of the communication line 30.

The storage unit 22 stores log data for a predetermined period of time. The log data is data for storing detection item DE related to a communication protocol error including the communication protocol error detected by the execution unit 21.

The storage unit 22 has a transmission error counter, which is a counter indicating the number of communication protocol errors detected by the execution unit 21 when transmitting a data frame. The storage unit 22 also stores an error state of the communication device 20. The error condition is updated by the execution unit 21 based on the value of the transmission error counter.

The error condition is error active, error passive, or bus off. Error Active is a normal state that can participate in communication. Error passive is a state in which communication protocol errors are sporadic although they can participate in communication. Bus-off is a state in which communication cannot be participated due to a large number of communication protocol errors.

### Communication Protocol Error Detection

When transmitting a data frame, the execution unit 21 detects a bit error by monitoring the data frame transmitted by the communication device 20. To detect bit errors, the execution unit 21 monitors for each digital signal of the data frame.

The execution unit 21 confirms the difference between the data frame transmitted by the communication device 20 and the data frame acquired from the communication line 30. The execution unit 21 detects a bit error if there is a difference between the two data frames.

If there is a difference that the data frame transmitted by the communication device 20 is dominant, while the data frame acquired from the communication line 30 is recessive, the execution unit 21 detects a dominant bit error. A dominant bit error is a communication protocol error in which a dominant and a signal to be transmitted are transmitted with recessive. When the execution unit 21 detects a dominant bit error, the execution unit 21 stores information indicating that a dominant bit error has been detected in the log data of the storage unit 22.

If there is a difference that the data frame transmitted by the communication device 20 is recessive, while the data frame acquired from the communication line 30 is dominant, the execution unit 21 detects a recessive bit error. A recessive bit error is a communication protocol error in which recessive and a signal to be transmitted are transmitted as dominant. When the execution unit 21 detects a recessive bit error, the execution unit 21 stores information indicating that a recessive bit error has been detected in the log data of the storage unit 22. In this way, the execution unit 21 detects dominant bit errors and recessive bit errors by performing so-called bit monitoring.

When transmitting a data frame, the execution unit 21 detects a form error by monitoring CRC delimiter, ACK delimiter, and EOF of the data frame transmitted by the communication device 20. Form errors are communication protocol errors in which recessive and a range of digital signals to be transmitted are transmitted as dominant. CRC delimiter, ACK delimiter, and EOF are defined as areas to be recessive in advance. When at least one of CRC delimiter, ACK delimiter, and EOF is dominant, the execution unit 21 detects a form error. In this way, the execution unit 21 detects a form error by performing a so-called form check.

When receiving the data frame transmitted from the other communication device 20, the execution unit 21 compares the value of CRC of the received data frame with the value of the calculated CRC. When the value of CRC of the received data frame matches the value of the computed CRC, the execution unit 21 transmits ACK to the communication device 20 that is the source of the data frame. On the other hand, when the value of CRC of the received frame does not coincide with the value of the calculated CRC, the execution unit 21 detects CRC error and does not transmit ACK to the communication device 20 that is the source of the data frame.

When a data frame is transmitted from the communication device 20, the execution unit 21 detects an ACK error when ACK is not transformed from another communication device 20 connected via the communication line 30. ACK error is a communication protocol error in which the communication device 20 of the communication destination cannot correctly receive the data frame. That is, when the other communication device 20 does not return the dominant in ACK slot, the execution unit 21 detects ACK error. In this way, the execution unit 21 detects an ACK error by performing a so-called acknowledge check.

When a communication protocol error is detected when transmitting a data frame from the communication device 20, the execution unit 21 counts up the transmission error counter by the first specified amount. The first specified amount is “8”. On the other hand, when transmitting a data frame from the communication device 20, if no communication protocol error is detected, the execution unit 21 counts down the transmission error counter by the second specified amount. The second specified amount is “3”.

When the transmission error counter is equal to or less than the first specified value, the execution unit 21 shifts the error state to error active. The first specified value is “127”. The execution unit 21 shifts the error state to error passive when the transmission error counter is greater than the first specified value and less than the second specified value that is greater than the first specified value. The second specified amount is “255”. The execution unit 21 transitions the error state to bus-off when the transmission error counter is equal to or greater than the second specified amount. When the error state is bus-off and a predetermined recovery condition is satisfied, the execution unit 21 shifts the error state to error passive.

When the error condition is error passive, the communication device 20 is restricted from transmitting frames for a certain period of time. When the error state is bus-off, the communication device 20 is prohibited from being connected to the communication line 30.

When the execution unit 21 detects a communication protocol error when the error condition is error passive, it transmits a passive error flag. The passive error flag is a 6-bit recessive signal. Upon detecting the passive error flag via the communication line 30, the execution unit 21 stores information indicating that a passive error has been detected in the storage unit 22.

When returning the error state from the bus-off state to the error-passive state, the execution unit 21 stores information indicating that there is a history of the bus-off return in the log data of the storage unit 22. The condition for returning from bus-off to error-passive is that the execution unit 21 detects 11 recessives on the communication line 30 128 times. That is, when the execution unit 21 determines that the recovery condition is satisfied, the execution unit 21 detects that the communication device 20 connected to the communication line 30 has a history of detecting a communication protocol error in a predetermined period of time in the past until the error state becomes bus-off. That is, the bus-off recovery indicates that the communication device 20 connected to the communication line 30 has detected a communication protocol error of a certain amount or more in the past certain period.

### Outline of Estimating Device

Next, the estimating device 40 that estimates the failure mode MD of the communication line 30 of the communication system 10 will be described. The estimating device 40 is connected to the communication device 20. The estimating device 40 is capable of acquiring information stored in the storage unit 22 of the communication device 20.

The estimating device 40 includes an executing device 41 that is a CPU, peripheral circuitry 42, a RAM 43, a storage device 44, and a bus 45. The bus 45 communicatively connects the executing device 41, the peripheral circuitry 42, RAM 43, and the storage device 44 to each other. The peripheral circuitry 42 includes a circuit that generates a clock signal that defines an internal operation, a power supply circuit, a reset circuit, and the like. RAM 43 stores data generated in association with the operation of the executing device 41. The storage device 44 stores the estimation program PR of the failure mode MD of the communication line 30 and the relation information RI referred to when the estimation program PR is executed. In the present embodiment, the execution device 41 is an execution unit and the storage device 44 is a storage unit.

### Relation Information

As illustrated in FIG. 2, the relation information RI includes error information ER including a plurality of types of detection item DE related to a communication protocol error, and information indicating a failure mode MD. In the relation information RI, failure mode MD is associated with each detection item DE. The detection item DE has dominant bit error, recessive bit error, ACK error, form error, bus-off return, and error-passive flags. The failure mode MD includes short-circuiting and a disconnection of the communication line 30. A short-circuiting of the communication line 30 or a disconnection of the communication line 30 is linked to the respective detection item DE as a failure mode MD.

The relation information RI includes information indicating an occurrence-probability FP of the failure mode MD associated with the detection item DE. The occurrence probability FP is a probability of occurrence of a failure in the failure mode MD associated with the detection item DE when the detection item DE is detected.

The failure mode MD associated with the dominant bit error is short-circuiting of the communication line 30. When a dominant bit error is detected, the occurrence probability FP at which a failure occurs in short-circuiting of the communication line 30 is the first probability P1.

The failure mode MD associated with the recessive bit error is a disconnection of the communication line 30. When a recessive bit error is detected, the occurrence probability FP at which a failure occurs in the disconnection of the communication line 30 is the second probability P2.

The failure mode MD associated with ACK error is a disconnection of the communication line 30. When an ACK error is detected, the occurrence probability FP at which a failure occurs in the disconnection of the communication line 30 is the third probability P3.

The failure mode MD associated with the form error is a disconnection of the communication line 30. When a form error is detected, the occurrence probability FP at which a failure occurs due to disconnection of the communication line 30 is the fourth probability P4.

The failure mode MD associated with the bus-off recovery is a disconnection of the communication line 30. When the bus-off recovery is detected, the occurrence probability FP at which a failure occurs in the disconnection of the communication line 30 is the fifth probability P5.

The failure mode MD associated with the error passive flag is short-circuiting of the communication line 30. When the error passive flag is detected, the occurrence probability FP at which a failure occurs in the short-circuiting of the communication line 30 is the fifth probability P5.

### Method for Generating Relation Information

Next, methods of generating the relation information RI will be described. The relation information RI has been experimentally generated in advance.

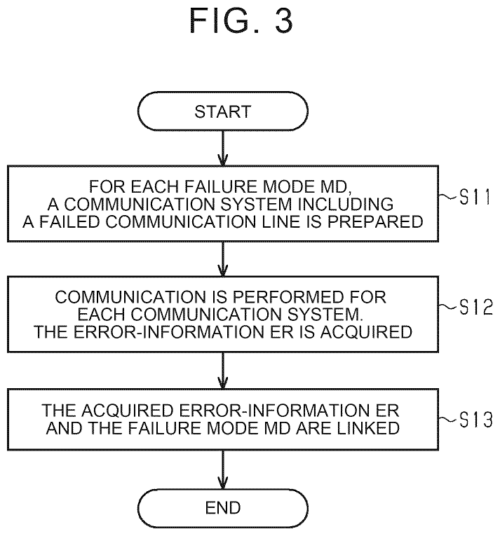

As illustrated in FIG. 3, the methods for generating the relation information RI include a preparing process S11, an obtaining process S12, and a linking process S13. In generating the relation information RI, the operator first performs the preparation process S11.

In the preparation process S11, the operator prepares a predetermined number of communication systems 10 including the failed communication lines 30 for each failure mode MD. Specifically, the communication system 10 in which one of the two signal lines included in the communication line 30 is disconnected and the communication system 10 in which the two signal lines included in the communication line 30 are short-circuited are prepared by a prescribed number. Thereafter, the operator advances the process to the acquiring process S12.

In the acquiring process S12, the operator starts communication based on CAN protocol by causing the plurality of communication devices 20 to communicate with each other in the communication system 10 including the failed communication line 30. As a result, the communication device 20 detects and stores DE of detection items by communication. Next, the operator acquires the detection item DE from the communication device 20 by using the fresh clean computer. Consequently, the generation computer acquires the detection item DE. Thereafter, the operator advances the process to the linking process S13.

In the association process S13, the operator associates the detection item DE acquired in the acquisition process S12 with the failure mode MD of the communication system 10 that has performed communication when the detection item DE is acquired, using the generation computer. Specifically, the operator records the count detected by the communication in the communication system 10 including the disconnected communication line 30 for each of the dominant bit error, the recessive bit error, ACK error, the form error, the bus-off recovery, and the error passive flag. In other words, the operator counts the number of times of detection of DE of detection items among the prepared predetermined number of communication systems 10. Then, the operator calculates the probability of disconnection of the detection item DE based on the counted number of times of detection divided by a predetermined number.

Further, the operator records the counts detected by the communication in the communication system 10 including the short-circuited communication line 30 for each of the dominant bit error, the recessive bit error, ACK error, the form error, the bus-off recovery, and the error passive flag. In other words, the operator counts the number of times of detection of DE of detection items among the prepared predetermined number of communication systems 10. Then, the operator calculates the probability of short-circuiting the ratio of detecting the respective detection item DE on the basis of the counted number of times of detection divided by a predetermined number.

Next, the operator associates failure mode MD, which is a higher probability among the probability of occurrence of short-circuiting and the probability of occurrence of a disconnection, with respect to the respective detection item DE. Thus, the failure mode MD of the short-circuiting or the disconnection is associated with each of the dominant bit error, the recessive bit error, ACK error, the form error, the bus-off recovery, and the error passive flag. The operator uses the generation computer to generate the map data associated in this manner as the relation information RI.

### Processing of the Estimating Device

Next, a series of processes including the process of estimating the failure mode MD of the estimating device 40 will be described.

When a switch (not shown) is operated, the execution device 41 starts execution of the estimation program PR.

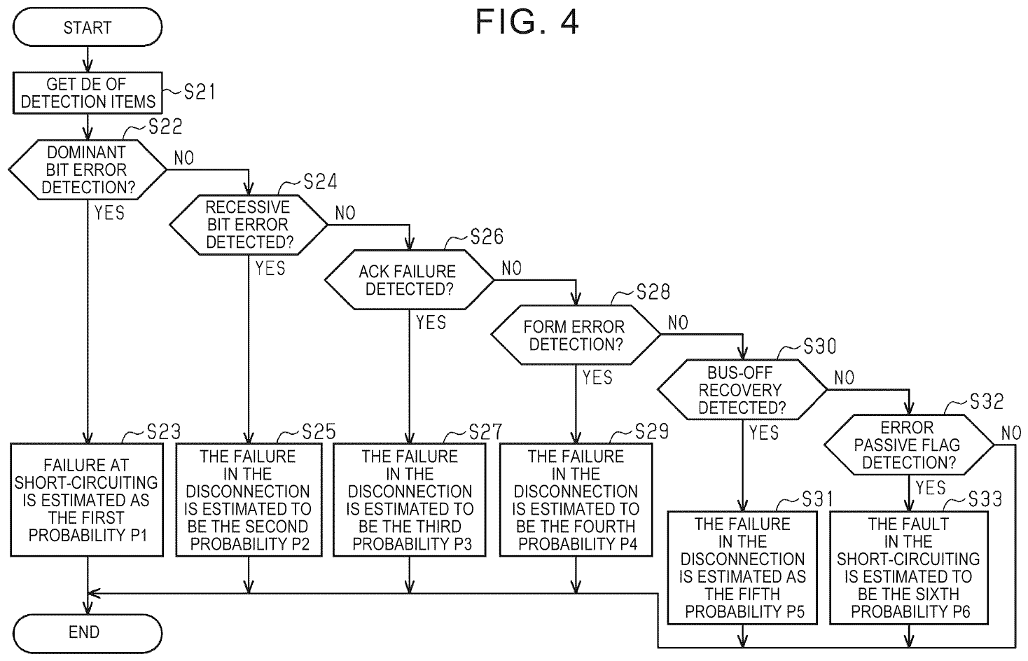

As illustrated in FIG. 4, when the execution device 41 starts execution of the estimation program PR, the execution device 41 first starts S21 process. In S21, the executing device 41 acquires the detection item DE from the connected communication device 20. Specifically, the execution device 41 acquires the log data of the storage unit 22 of the communication device 20 without acquiring the time-series data of the potential difference of the communication line 30. Thereafter, the executing device 41 advances the process to S22.

In S22, the executing device 41 determines whether a dominant bit error is detected in the acquired detection item DE. When a dominant bit error is detected (S22: YES), the executing device 41 advances the process to S23.

In S23, the executing device 41 refers to the relation information RI and estimates that a fault has occurred due to short-circuiting of the communication line 30, which is a failure mode MD associated with a dominant bit error. Further, the executing device 41 estimates that a failure in short-circuiting of the communication line 30 when a dominant bit error is detected occurs in the first probability P1. The execution device 41 outputs the estimation result to a monitor (not shown). Thereafter, the execution device 41 ends the current series of processes.

On the other hand, when a dominant bit error is not detected in the acquired detection item DE (S22: NO), the executing device 41 advances the process to S24. In S24, the executing device 41 determines whether or not a recessive bit error is detected in the acquired detection item DE. When a recessive bit error is detected (S24: YES), the executing device 41 advances the process to S25.

In S25, the executing device 41 refers to the relation information RI and estimates that the communication line 30, which is a failure mode MD associated with the recessive bit error, has failed due to a disconnection. Further, the executing device 41 estimates that a failure in disconnection of the communication line 30 when a recessive bit error is detected occurs in the second probability P2. The execution device 41 outputs the estimation result to a monitor (not shown). Thereafter, the execution device 41 ends the current series of processes.

On the other hand, when a recessive bit error is not detected in the acquired detection item DE (S24: NO), the executing device 41 advances the process to S26. In S26, the executing device 41 determines whether or not an ACK error has been detected in the acquired detection item DE. When an ACK error has been detected (S26: YES), the executing device 41 advances the process to S27.

In S27, the executing device 41 refers to the relation information RI and estimates that the failure has occurred due to the disconnection of the communication line 30, which is the failure mode MD associated with ACK error. Further, the executing device 41 estimates that a failure in the disconnection of the communication line 30 when ACK error is detected occurs in the third probability P3. The execution device 41 outputs the estimation result to a monitor (not shown). Thereafter, the execution device 41 ends the current series of processes.

On the other hand, when no ACK error is detected in the acquired detection item DE (S26: NO), the executing device 41 advances the process to S28. In S28, the executing device 41 determines whether or not a form error has been detected in the acquired detection item DE. When a form error is detected (S28: YES), the executing device 41 advances the process to S29.

In S29, the executing device 41 refers to the relation information RI and estimates that the failure has occurred due to the disconnection of the communication line 30, which is the failure mode MD associated with the form error. Further, the executing device 41 estimates that a failure in disconnection of the communication line 30 when a form error is detected occurs in the fourth probability P4. The execution device 41 outputs the estimation result to a monitor (not shown). Thereafter, the execution device 41 ends the current series of processes.

On the other hand, when a form error is not detected in the acquired detection item DE (S28: NO), the executing device 41 advances the process to S30. In S30, the executing device 41 determines whether or not bus-off recovery is detected in the acquired detection item DE. When the bus-off recovery is detected (S30: YES), the executing device 41 advances the process to S31.

In S31, the executing device 41 refers to the relation information RI and estimates that the failure has occurred due to the disconnection of the communication line 30, which is the failure mode MD associated with the bus-off recovery. Further, the executing device 41 estimates that a failure in the disconnection of the communication line 30 at the time of detecting the bus-off recovery occurs in the fifth probability P5. The execution device 41 outputs the estimation result to a monitor (not shown). Thereafter, the execution device 41 ends the current series of processes.

On the other hand, when the bus-off recovery is not detected in the acquired detection item DE (S30: NO), the executing device 41 advances the process to S32. In S32, the executing device 41 determines whether or not an error passive flag is detected in the acquired detection item DE. When the error passive flag is detected (S32: YES), the executing device 41 advances the process to S33.

In S33, the executing device 41 refers to the relation information RI and estimates that a failure has occurred due to short-circuiting of the communication line 30, which is a failure mode MD associated with the error passive flag. Further, the executing device 41 estimates that a failure in the disconnection of the communication line 30 when the error passive flag is detected occurs in the sixth probability P6. The execution device 41 outputs the estimation result to a monitor (not shown). Thereafter, the execution device 41 ends the current series of processes.

On the other hand, when the error passive flag is not detected in the acquired detection item DE (S32: NO), the executing device 41 does not estimate the failure mode MD and ends the series of processes at this time. In this case, the execution device 41 outputs an image indicating that it cannot be estimated to a monitor (not shown).

### Operations of Embodiment

According to the above-described embodiment, in the communication system 10, the communication device 20 performs communication to detect DE of detection items caused by the communication protocol error. Then, the estimating device 40 acquires the detection item DE from the communication device 20 when estimating the failure mode MD. After that, the estimating device 40 estimates the failure mode MD based on the acquired detection item DE and the relation information RI.

### Effects of Embodiment

According to the above-described embodiment, the estimating device 40 obtains the detection item DE detected by the communication device 20, and estimates the failure mode MD by referring to the relation information RI. Therefore, the estimating device 40 does not need to detect DE of detection items based on the voltage of the communication line 30. Therefore, the estimating device 40 can estimate the failure mode MD without performing an excessively complicated process.

According to the above embodiment, the plurality of types of detection items DE includes a dominant bit error. The failure mode MD associated with the dominant bit error is short-circuiting of the communication line 30. Therefore, according to the estimating device 40, when the communication device 20 detects a dominant bit error, it is possible to estimate a failure due to short-circuiting of the communication line 30. When a dominant bit error is detected, there is a high possibility that a potential difference constituting the dominant is not created. When one of the two signal lines constituting the communication line 30 is short-circuited to the other, a potential difference between the two signal lines does not occur. Therefore, when a dominant bit error is detected, it is considered that short-circuiting occurs in the communication line 30.

According to the above embodiment, the plurality of types of detection items DE includes a recessive bit error. The failure mode MD associated with the recessive bit error is a disconnection of the communication line 30. Therefore, according to the estimating device 40, when the communication device 20 detects a recessive bit error, it is possible to estimate a failure due to disconnection of the communication line 30. When a recessive bit error is detected, there is a high possibility that a potential difference constituting the dominant is continuously generated. When one of the two signal lines constituting the communication line 30 is disconnected, a potential difference may continue to occur with the other signal line. Therefore, when a recessive bit error is detected, it is considered that disconnection of the communication line 30 has occurred.

According to the above embodiment, the plurality of types of detection items DE include ACK errors. The failure mode MD associated with ACK error is a disconnection of the communication line 30. Therefore, according to the estimating device 40, when the communication device 20 detects an ACK error, it is possible to estimate a failure due to disconnection of the communication line 30. When an ACK error is detected, there is a possibility that the potential difference constituting the dominant is not created, and the dominant and the signal to be transmitted are transmitted as recessive. When one of the two signal lines constituting the communication line 30 is disconnected, a potential difference may continue to occur with the other signal line. Therefore, when an ACK error is detected, it is considered that disconnection of the communication line 30 has occurred.

According to the above embodiment, the plurality of types of detection items DE includes a form error. The failure mode MD associated with the form error is a disconnection of the communication line 30. Therefore, according to the estimating device 40, when the communication device 20 detects a form error, it is possible to estimate a failure due to disconnection of the communication line 30. When a form error is detected, there is a possibility that a signal to be transmitted as a dominant signal is transmitted as a recessive signal without creating a potential difference constituting the dominant signal. When one of the two signal lines constituting the communication line 30 is disconnected, a potential difference may continue to occur with the other signal line. Therefore, when an ACK error is detected, it is considered that disconnection of the communication line 30 has occurred.

According to the above embodiment, the plurality of types of detection items DE includes bus-off recovery. The failure mode MD associated with the bus-off recovery is a disconnection of the communication line 30. Therefore, according to the estimating device 40, when the communication device 20 detects the bus-off recovery, it is possible to estimate the failure of the communication line 30. When the bus-off recovery flag can be detected, the communication device 20 is capable of configuring a recessive as a recovery condition. If recessive can be configured, the communication line 30 is not short-circuited. Then, when a communication protocol error is detected in the past, it is considered that disconnection of the communication line 30 has occurred.

According to the above embodiment, the plurality of types of detection items DE includes an error passive flag. The failure mode MD associated with the error passive flag is short-circuiting of the communication line 30. Therefore, according to the estimating device 40, when the communication device 20 detects the error passive flag, it is possible to estimate the short-circuiting of the communication line 30. When the error passive flag is excessively detected, it is highly likely that the potential difference constituting the dominant cannot be created. When one of the two signal lines constituting the communication line 30 is short-circuited to the other, a potential difference between the two signal lines does not occur. Therefore, when the error passive flag is detected, it is considered that short-circuiting occurs in the communication line 30.

### Other Embodiments

The present embodiment can be realized with the following modifications. The present embodiment and the following modifications can be combined with each other within a technically consistent range to be realized.

The detection item DE may not include a dominant bit error. The detection item DE may not include a recessive bit error. The detection item DE may not include an ACK error. The detection item DE may not include a form error. The detection item DE may not include the bus-off recovery flag. The detection item DE may not include an error passive flag. The detection items DE may include other communication protocol errors. Other communication protocol errors may include, for example, CRC errors and stuffing errors that the communication device 20 detects when receiving a data frame. The detection items DE are not limited to the exemplary embodiments described above.

In the relation information RI, the failure mode MD associated with the respective detection item DE may be different from those in the above-described embodiment. It may be determined based on the generated relation information RI.
The methods for generating the relation information RI are not limited to the exemplary embodiments described above. For example, the relation information RI may be simulated or machine-learned.

The estimating device 40 may acquire the detection item DE from the communication device 20 by radio communication. The estimating device 40 may be configured as a circuitry including one or more processors that execute various processes in accordance with a computer program (software). Note that the estimating device 40 may be configured as a circuit including one or more dedicated hardware circuits such as an application-specific integrated circuit (ASIC) that executes at least some of the various processes, or a combination thereof. The processor includes a CPU and a memory such as a random access memory (RAM) and a ROM. The memory stores a program code or an instruction configured to execute the CPU to perform processes. The memory, that is, the computer-readable medium includes any available media that can be accessed by a general purpose or special purpose computer.

What is claimed is:

1. An estimating device that estimates a failure mode of a communication line in a communication system that includes a plurality of communication devices in which communication based on a controller area network protocol is performed via the communication line, the estimating device comprising:
a storage unit; and
an execution unit, wherein
the storage unit stores relation information that includes error information including a plurality of types of detection items related to communication protocol errors, and the failure mode associated with each of the detection items, and
the execution unit executes
acquiring, from the communication device, the detection item that is detected by the communication device, and
estimating that a failure is occurring in the failure mode associated with the detection item that is acquired and the relation information.

2. The estimating device according to claim 1, wherein
the types of detection items include a dominant bit error, and
the failure mode associated with the dominant bit error is short-circuiting of the communication line.

3. The estimating device according to claim 1, wherein
the types of detection items include a recessive bit error, and
the failure mode associated with the recessive bit error is disconnection of the communication line.

4. The estimating device according to claim 1, wherein
the types of detection items include an ACK error, and
the failure mode associated with the ACK error is disconnection of the communication line.

5. The estimating device according to claim 1, wherein
the types of detection items include a form error, and
the failure mode associated with the form error is disconnection of the communication line.
